(19) United States
(12) Patent Application Publication
(10) Pub. No.: US 2026/0319584 A1
(43) Pub. Date: Oct. 15, 2026

(54) ADAPTIVE WINDOW-BASED ASYNCHRONOUS STEADY STATE VISUALLY EVOKED POTENTIAL TRACKING DEVICE AND METHOD

(71) Applicants: HYUNDAI MOTOR COMPANY, Seoul (KR); Kia Corporation, Seoul (KR)

(72) Inventors: Seungkyu NAM, Hwaseong-si (KR); Taejun LEE, Hwaseong-si (KR); Hoseung CHA, Hwaseong-si (KR)

(21) Appl. No.: 19/421,163

(22) Filed: Dec. 16, 2025

(30) Foreign Application Priority Data
Apr. 9, 2025 (KR) 10-2025-0045982

(51) Int. Cl. G06F 3/01; G06F 3/04845; G06F 3/04886

(52) U.S. Cl. CPC G06F 3/015; G06F 3/04845; G06F 3/04886; G06F 2203/04803

(57) ABSTRACT

An adaptive window-based asynchronous steady state visually evoked potential (SSVEP) tracking device receives an EEG signal of a user, when a presentation of a visual stimulation begins, identifies a control intention of the user for the visual stimulation based on the EEG signal, when it is identified that there is no control intention, tracks an SSVEP signal based on a first fixed window, when it is identified that there is the control intention, tracks the SSVEP signal based on an adaptive window, when it is identified that the user controls the visual stimulation and has the control intention based on the tracked SSVEP signal, increases a size of the adaptive window, and when it is identified that the user does not control the visual stimulation based on the tracked SSVEP signal, decreases the size of the adaptive window.

### CROSS-REFERENCE TO RELATED APPLICATION

This application claims priority to and the benefit of Korean Patent Application No. 10-2025-0045982 filed with the Korean Intellectual Property Office on Apr. 9, 2025, the entire contents of which are incorporated herein by reference.

### TECHNICAL FIELD

The present disclosure relates to an adaptive window-based asynchronous steady state visually evoked potential (SSVEP) tracking device and method, and more specifically, to an adaptive window-based asynchronous SSVEP tracking device and method implemented in a closed-loop brain-computer Interface (BCI) system for exercise rehabilitation of stroke patients based on action observation (AO).

### BACKGROUND

Neuro-robotic rehabilitation for stroke patients is a rehabilitation technology that combines neuroscience technology to understand exercise intentions with accurate intensity and repeatable robots.

Brain-computer interface (BCI) technology may be used to understand the patient's exercise intention. The closed-loop system built through BCI technology may promote cranial nerve plasticity (brain nerve reconstruction and relocation) by synchronizing the centrifugal nerve (top-down) and the centripetal nerve (bottom-up).

Existing BCI-based neurorehabilitation technologies may be based on motor imagery (MI), which is one paradigm of BCI.

MI-BCI may be a slightly more intuitive methodology for neurorehabilitation for motor recovery in stroke patients by activating the cerebral motor region with exercise imagination.

However, in the case of MI-BCI technology, a lot of time may be spent on data acquisition for EEG classification model training, and there may be many problems, such as difficulty in performing the MI paradigm, low classification performance, and a number of illiteracy.

### SUMMARY

Aspects of the present disclosure can provide an adaptive window-based asynchronous steady state visual evoked potential (SSVEP) tracking device and method that can improve the problems of existing MI-brain-computer Interface (BCI)-based technology by applying the SSVEP technology based on action observation (AO).

Aspects of the present disclosure may also provide an adaptive window-based asynchronous SSVEP tracking device and method that can implement a closed-loop BCI system for AO-based exercise rehabilitation of stroke patients, track SSVEP responses in real time, and identify AO status.

An exemplary implementation of the present disclosure provides an adaptive window-based asynchronous steady state visually evoked potential (SSVEP) tracking device including one or more processors; and memory storing instructions that, when executed by the one or more processors, cause the adaptive window-based asynchronous SSVEP tracking device to: receive an electroencephalogram (EEG) signal of a user, based on starting a presentation of a visual stimulation, determine a control intention of the user for the visual stimulation based on the EEG signal, based on determining that there is no control intention, track an SSVEP signal based on a first fixed window, based on determining that there is the control intention, track the SSVEP signal based on an adaptive window, based on determining that the user controls the visual stimulation and has the control intention based on the tracked SSVEP signal, increase a size of the adaptive window, based on determining that the user does not control the visual stimulation based on the tracked SSVEP signal, decrease the size of the adaptive window, and based on determining that the user does not control the visual stimulation and has no control intention, stop the presentation of the visual stimulation.

The instructions, when executed by the one or more processors, can cause the adaptive window-based asynchronous SSVEP tracking device to determine the control intention of the user for the visual stimulation based on the EEG signal by: determining a first EEG signal in a standby state before the presentation of the visual stimulation as a base signal, and determining a second EEG signal in an intentional control state for the visual stimulation as an outlier; detecting the outlier based on a normalized feature of the first EEG signal; and determining that there is the control intention for the visual stimulation based on detecting the outlier.

The instructions, when executed by the one or more processors, can cause the adaptive window-based asynchronous SSVEP tracking device to detect the outlier based on the normalized feature of the first EEG signal by estimating a normal distribution from features collected in the standby state, and estimating the outlier through a mean and standard deviation

The instructions, when executed by the one or more processors, can cause the adaptive window-based asynchronous SSVEP tracking device to track the SSVEP signal based on the adaptive window based on determining that there is the control intention by multi-tracking the SSVEP signal by using a second fixed window together with the adaptive window.

The instructions, when executed by the one or more processors, can cause the adaptive window-based asynchronous SSVEP tracking device to increase the size of the adaptive window based on determining that the user controls the visual stimulation and has the control intention based on the tracked SSVEP signal by, based on detecting the control state based on the SSVEP signal tracked through the adaptive window or the second fixed window, increasing the size of the adaptive window to a preset maximum size based on the detected control state.

The instructions, when executed by the one or more processors, can cause the adaptive window-based asynchronous SSVEP tracking device to increase the size of the adaptive window based on determining that the user controls the visual stimulation and has the control intention based on the tracked SSVEP signal further by, based on the size of the adaptive window reaching the preset maximum size, maintaining the preset maximum size and tracking the SSVEP signal.

The instructions, when executed by the one or more processors, can cause the adaptive window-based asynchronous SSVEP tracking device to decrease the size of the adaptive window based on determining that the user does not control the visual stimulation based on the tracked SSVEP signal by: based on detecting the non-control state of the user for the visual stimulation based on the SSVEP signal tracked through the second fixed window, decreasing the size of the adaptive window; and determining whether the user controls the visual stimulation based on the SSVEP signal tracked through the adaptive window.

The instructions, when executed by the one or more processors, can cause the adaptive window-based asynchronous SSVEP tracking device to stop the presentation of the visual stimulation based on determining that the user does not control the visual stimulation and has no control intention by stopping the presentation of the visual stimulation based on detecting the non-control state according to both a result of the tracking of the SSVEP signal through the adaptive window and a result of the tracking of the SSVEP signal through the second fixed window.

The instructions, when executed by the one or more processors, can cause the adaptive window-based asynchronous SSVEP tracking device to, based on detecting the control state according to both a result of the tracking of the SSVEP signal through the second fixed window and a result of the tracking of the SSVEP signal through the adaptive window during a decrease in the size of the adaptive window, increase the size of the adaptive window that has been decreasing.

In some implementations, an adaptive window-based asynchronous steady state visually evoked potential (SSVEP) tracking method performed by a computing device including one or more processors and a memory is provided. The adaptive window-based asynchronous SSVEP tracking method can include receiving, by the one or more processors, an electroencephalogram (EEG) signal of a user; based on starting a presentation of a visual stimulation, determining, by the one or more processors, a control intention of the user for the visual stimulation based on the EEG signal; based on determining that there is no control intention, tracking, by the one or more processors, an SSVEP signal based on a first fixed window; based on determining that there is the control intention, tracking, by the one or more processors, the SSVEP signal based on an adaptive window; based on determining that the user controls the visual stimulation and has the control intention based on the tracked SSVEP signal, increasing, by the one or more processors, a size of the adaptive window; based on determining that the user does not control the visual stimulation based on the tracked SSVEP signal, decreasing, by the one or more processors, the size of the adaptive window; and based on determining that the user does not control the visual stimulation and has no control intention, stopping, by the one or more processors, the presentation of the visual stimulation.

The determining of the control intention of the user for the visual stimulation based on the EEG signal based on starting the presentation of the visual stimulation begins can include: determining, by the one or more processors, a first EEG signal in a standby state before the presentation of the visual stimulation as a base signal, and determining a second EEG signal in an intentional control state for the visual stimulation as an outlier; detecting the outlier based on a normalized feature of the first EEG signal; and determining that there is the control intention for the visual stimulation based on detecting the outlier.

The detecting of the outlier based on the normalized feature of the first EEG signal can include estimating a normal distribution from features collected in the standby state, and estimating the outlier through a mean and standard deviation.

The tracking of the SSVEP signal based on the adaptive window based on determining that there is the control intention can include multi-tracking the SSVEP signal by using a second fixed window together with the adaptive window.

The multi-tracking of the SSVEP signal by using the second fixed window together with the adaptive window can include preferentially tracking a control state or a non-control state of the user for the visual stimulation by using the second fixed window.

The increasing of the size of the adaptive window based on determining that the user controls the visual stimulation and has the control intention based on the tracked SSVEP signal can include, based on detecting the control state based on the SSVEP signal tracked through the adaptive window or the second fixed window, increasing the size of the adaptive window to a preset maximum size based on the detected control state.

The increasing of the size of the adaptive window based on determining that the user controls the visual stimulation and has the control intention based on the tracked SSVEP signal can include, based on the size of the adaptive window reaching the preset maximum size, maintaining the preset maximum size and tracking the SSVEP signal.

The decreasing of the size of the adaptive window based on determining that the user does not control the visual stimulation based on the tracked SSVEP signal can include: based on detecting the non-control state of the user for the visual stimulation based on the SSVEP signal tracked through the second fixed window, decreasing the size of the adaptive window; and determining whether the user controls the visual stimulation based on the SSVEP signal tracked through the adaptive window.

The stopping of the presentation of the visual stimulation based on determining that the user does not control the visual stimulation and has no control intention can include stopping the presentation of the visual stimulation based on detecting the non-control state according to both a result of the tracking of the SSVEP signal through the adaptive window and a result of the tracking of the SSVEP signal through the second fixed window.

The method can include, based on detecting the control state according to both a result of the tracking of the SSVEP signal through the second fixed window and a result of the tracking of the SSVEP signal through the adaptive window during a decrease in the size of the adaptive window, increasing the size of the adaptive window that has been decreasing.

### BRIEF DESCRIPTION OF THE DRAWINGS

FIG. 1 is a diagram schematically illustrating a brain-computer interface (BCI) system using an adaptive window-based asynchronous steady state visually evoked potential (SSVEP) tracking method according to an exemplary implementation of the present disclosure.

FIG. 2 is a block diagram of an adaptive window-based asynchronous SSVEP tracking device according to an exemplary implementation of the present disclosure.

FIGS. 3 and 4 are flowcharts of the adaptive window-based asynchronous SSVEP tracking method according to the exemplary implementation of the present disclosure.

FIG. 5 is a graph illustrating a change in CCA feature characteristics according to a time window size according to the exemplary implementation of the present disclosure.

FIGS. 6A and 6B are flowcharts of the adaptive window-based asynchronous SSVEP tracking method according to the exemplary implementation of the present disclosure.

FIGS. 7A and 7B are graphs illustrating effects according to the exemplary implementation of the present disclosure.

FIG. 8 is a diagram illustrating a computing device according to an exemplary implementation of the present disclosure.

### DETAILED DESCRIPTION

The present disclosure will be described more fully hereinafter with reference to the accompanying drawings, in which exemplary implementations of the present disclosure are shown. As those skilled in the art would realize, the described exemplary implementations can be modified in various different ways, all without departing from the spirit or scope of the present disclosure. Accordingly, the drawings and description are to be regarded as illustrative in nature and not restrictive. Like reference numerals designate like elements throughout the specification.

In addition, the terms “… unit”, “…or”, and “… module” described in the specification mean units for processing at least one function and operation and can be implemented by hardware components or software components and combinations thereof.

Furthermore, at least some of the configurations or functions of an adaptive window-based asynchronous steady state visually evoked potential (SSVEP) tracking device and method according to the exemplary implementations described below can be implemented as programs or software, and programs or software can be stored in computer-readable media.

Hereinafter, exemplary implementations of the present disclosure will be described with reference to the drawings.

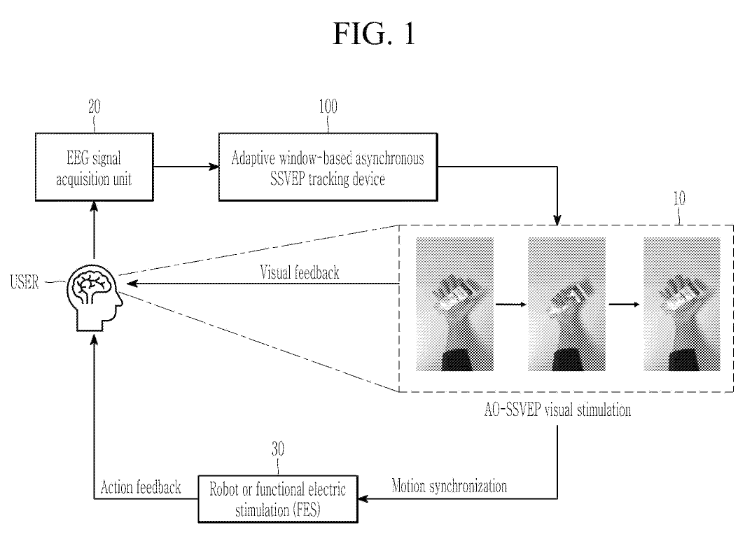

FIG. 1 is a diagram schematically illustrating a BCI system using an adaptive window-based asynchronous steady state visually evoked potential (SSVEP) tracking method according to an exemplary implementation of the present disclosure.

Referring to FIG. 1, the BCI system can include an action observation (AO)-SSVEP visual stimulation presentation unit 10, an electroencephalogram (EEG) signal acquisition unit 20, a rehabilitation device unit 30, and an adaptive window-based asynchronous SSVEP tracking device 100.

In FIG. 1, the brain-computer interface (BCI) system can include a closed-loop system for motor nerve rehabilitation of stroke patients.

The BCI system can include a neurorehabilitation methodology implemented with high performance and high cognitive speed using SSVEP technology based on AO.

The BCI system can perform a rehabilitation exercise motion when it is determined that a user controls the stimulation. The BCI system may no longer operate when it is determined that the user does not control the stimulation.

The AO-SSVEP visual stimulation presentation unit 10 can present the AO-SSVEP visual stimulation to the user.

The user can be a rehabilitation treatment target with a disability. For example, the user can be a stroke patient. The user (USER) can receive neurorehabilitation treatment or the like by controlling the presented AO-SSVEP visual stimulation.

AO can be a principle in which the cerebral motor region is activated, like directly performing the corresponding operation just by observing a specific operation by the Mirror Neuron System.

The SSVEP can mean an EEG signal in which EEG measured in the visual region of the cerebrum is synchronized with the stimulation frequency when a user controls a visual stimulation blinking at a specific frequency. SSVEP can be referred to as an SSVEP signal.

SSVEP can include steady-state motion visual evoked potential (SSMVEP). SSMVEP can be an induced potential that occurs when a user glares at moving visual stimulation (e.g., a movement of a user's hand, etc.).

For example, the AO-SSVEP visual stimulation can basically be a visual stimulation including a user's motion and/or flickering based on action observation.

The AO-SSVEP visual stimulation presentation unit 10 can provide visual feedback to a user (USER) controlling the AO-SSVEP visual stimulation.

The visual feedback can be synchronized with the SSVEP signal.

The visual feedback can include a shape that changes according to the user's controlling state, and can be disposed in visual stimulation. The visual feedback can immediately respond to the user's controlling state.

The AO-SSVEP visual stimulation presentation unit 10 can track the user's controlling state and increase the user's controlling concentration, for example, by providing visual feedback to the user.

The EEG signal acquisition unit 20 can acquire an EEG signal through an electrode attached to the scalp of the user. The EEG signal can be referred to as an electroencephalogram signal.

The EEG signal acquisition unit 20 can acquire an EEG signal activated through visual feedback provided through the AO-SSVEP visual stimulation presentation unit 10.

The rehabilitation device unit 30 can include a rehabilitation device that moves in synchronization with the presented AO-SSVEP visual stimulation. For example, the rehabilitation device unit 30 can control the rehabilitation device in response to the AO-SSVEP visual stimulation.

The rehabilitation device can include a robotic system or a functional electrical stimulation (FES) application, such as an FES bike for assisted pedaling, an FES walking system for gait training, or an upper limb FES system to support grasping and reaching movements. Additional examples of rehabilitation devices include physical rehabilitation tools like prosthetics and exoskeletons; neurological rehabilitation systems such as EEG-based brain-computer interfaces, robotic arm trainers, and virtual reality-based therapy platforms; and speech or cognitive rehabilitation devices, including speech-generating devices (SGDs).

The rehabilitation device unit 30 can provide action feedback to the user USER through the operation of the rehabilitation device. The rehabilitation device unit 30 can transmit the same rehabilitation action feedback as the visual sense to the user.

The adaptive window-based asynchronous SSVEP tracking device 100 can receive an EEG signal from the EEG signal acquisition unit 20.

The adaptive window-based asynchronous SSVEP tracking device 100 can acquire an EEG signal by SSVEP visual stimulation, and the EEG can continuously track a control state of the user through signal processing.

The adaptive window-based asynchronous SSVEP tracking device 100 can determine the control intention of the user and control state for the AO-SSVEP visual stimulation based on the EEG signal.

The adaptive window-based asynchronous SSVEP tracking device 100 can determine the control intention of the user based on the EEG signal.

The adaptive window-based asynchronous SSVEP tracking device 100 can analyze the EEG signal to acquire and track the SSVEP signal, and determine the user's control state based on the SSVEP signal.

For example, the adaptive window-based asynchronous SSVEP tracking device 100 can determine the user's control state based on visual feedback presented to the user.

The adaptive window-based asynchronous SSVEP tracking device 100 can prevent misclassification due to EEG variability by using an adaptive window whose size can vary according to the control intention of the user and control state.

The adaptive window-based asynchronous SSVEP tracking device 100 can use an asynchronous method of determining and continuously tracking a user's intentional stimulation control state (intentional control state) or non-control state for visual stimuli that can be presented on a monitor.

As the time window increases due to the characteristics of the normalized feature, the SSVEP cognitive performance can increase but the response rate can decrease.

Therefore, the adaptive window-based asynchronous SSVEP tracking device 100 can apply a moving window (sliding window) technique that can adaptively change in size depending on the state instead of a fixed window, for more stable asynchronous SSVEP response tracking.

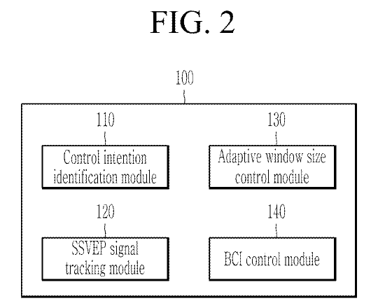

FIG. 2 is a block diagram of the adaptive window-based asynchronous SSVEP tracking device according to the exemplary implementation of the present disclosure.

The adaptive window-based asynchronous SSVEP tracking device 100 according to the exemplary implementation can execute a program code or instruction loaded in one or more memory devices through one or more processors.

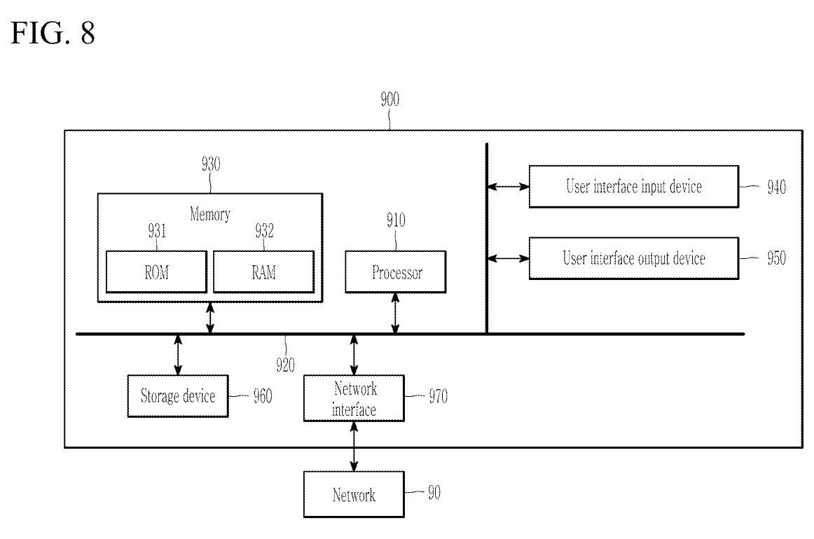

For example, the adaptive window-based asynchronous SSVEP tracking device 100 can be implemented with a computing device 900 as described later with reference to FIG. 8. In this case, one or more processors can correspond to the processor 910 of the computing device 900, and the one or more memory devices can correspond to the memory 930 of the computing device 900.

The program code or instruction can be executed by one or more processors to determine an action observation (AO) state for rehabilitation treatment and reduce misclassification due to non-control to visual stimulation. In this specification, the term "module" can be used to logically distinguish these functions performed by a program code or instruction.

Referring to FIG. 2, the adaptive window-based asynchronous SSVEP tracking device 100 can include a control intention identification module 110, an SSVEP signal tracking module 120, an adaptive window size control module 130, and a BCI control module 140.

The control intention identification module 110 can classify an intentional control state of the user's rehabilitation and a non-control state that the user does not want to use the system.

When the presentation of the visual stimulation starts, the control intention identification module 110 can identify the control intention of the user with respect to the visual stimulation based on the EEG signal.

The control intention identification module 110 can use a first EEG signal in a standby state before the presentation of the visual stimulation as a base signal, and determine a second EEG signal in the intentional control state with respect to the visual stimulation as an outlier.

For example, the control intention identification module 110 can assume that the EEG feature data for SSVEP visual stimulation control is outlier by using the EEG in a non-control state in which the user is not exposed to stimulation as a base signal.

The control intention determination module 110 can perform an outlier detection algorithm based on the normalized feature of an EEG signal in a standby state without exposure to stimuli.

For instance, the control intention identification module 110 can detect the outlier based on the normalized feature of the first EEG signal in the standby state.

For example, the control intention identification module 110 can estimate the normal distribution from features collected in the standby state and estimate the outlier through the mean and standard deviation.

The mean of the normal distribution can converge to (1/frequency stimulation number) as the collected data increases.

In addition, when the outlier is detected, the control intention identification module 110 can identify that the user has a control intention for the visual stimulation.

When it is determined that the user has no control intention, the SSVEP signal tracking module 120 can track the SSVEP signal based on a first fixed window.

The SSVEP signal tracking module 120 can extract and track SSVEP signal characteristics using a short basic fixed moving window to secure an initial fast reaction speed.

When it is determined that the user has the control intention, the SSVEP signal tracking module 120 can track the SSVEP signal based on the adaptive window.

The SSVEP signal tracking module 120 can multi-track the SSVEP signal by using a second fixed window together with the adaptive window.

The SSVEP signal tracking module 120 can preferentially track the control state or the non-control state of the user for the visual stimulation by using the second fixed window.

The response to the non-control state can be slow when the size of the adaptive window increases. Therefore, the SSVEP signal tracking module 120 can monitor whether the user is in the non-control state by using the fixed window together

The adaptive window size control module 130 can increase the size of the adaptive window when it is determined that the user controls the visual stimulation based on the tracked SSVEP signal and has the control intention.

When the control state is continuously detected based on the SSVEP signal tracked through the adaptive window or the second fixed window, the adaptive window size control module 130 can continuously increase the size of the adaptive window to a preset maximum size in response to the detected control state.

When the size of the adaptive window reaches the maximum size, the adaptive window size control module 130 can operate while maintaining the maximum size and can continuously track the SSVEP signal.

When it is determined that the user does not control the visual stimulation based on the tracked SSVEP signal, the adaptive window size control module 130 can decrease the size of the adaptive window.

When the non-control state of the user for the visual stimulation is detected based on the SSVEP signal tracked through the second fixed window, the adaptive window size control module 130 can decrease the size of the adaptive window.

The adaptive window size control module 130 can continuously determine whether the user controls the visual stimulation based on the SSVEP signal tracked through the adaptive window.

In some exemplary implementations, when it is detected that the user is in the control state according to both a result of the tracking of the SSVEP signal through the second fixed window and a result of the tracking of the SSVEP signal through the adaptive window while the size of the adaptive window decreases, the adaptive window size control module 130 can increase the decreased size of the adaptive window again.

The BCI control module 140 can control a standby state in which visual stimulation is not presented and an active state in which the visual stimulation is presented.

The BCI control module 140 can stop presenting the visual stimulation when it is determined that the user does not control the visual stimulation and has no control intention.

When it is detected that the user is in the non-control state according to both a result of the tracking of the SSVEP signal through the adaptive window and a result of the tracking of the SSVEP signal through the second fixed window, the BCI control module 140 can stop presenting the visual stimulation and stop the BCI system.

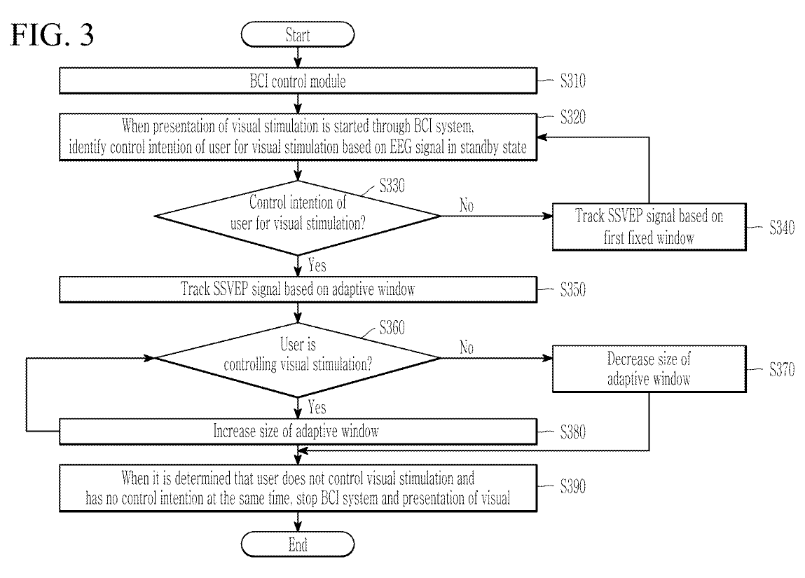

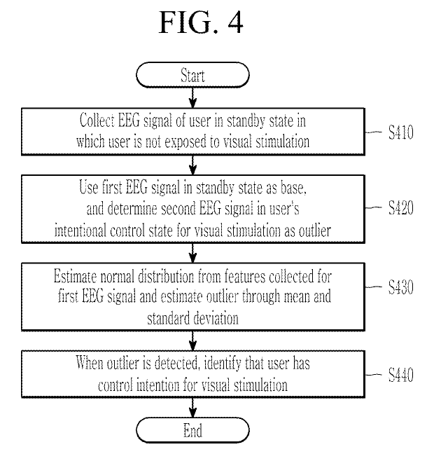

FIGS. 3 and 4 are flowcharts of the adaptive window-based asynchronous SSVEP tracking method according to some exemplary implementations of the present disclosure. The adaptive window-based asynchronous SSVEP tracking method of FIGS. 3 and 4 can be performed through the adaptive window-based asynchronous SSVEP tracking device 100 (see FIG. 2).

In FIG. 3, the adaptive window-based asynchronous SSVEP tracking device 100 can acquire an EEG signal of a user in a standby state (operation S310).

When the presentation of the visual stimulation is started through the BCI system, the adaptive window-based asynchronous SSVEP tracking device 100 can identify a control intention of the user for visual stimulation based on the EEG signal in the standby state (operation S320).

The adaptive window-based asynchronous SSVEP tracking device 100 can determine the control intention of the user for the visual stimulation (operation S330).

When it is determined that there is no control intention, the adaptive window-based asynchronous SSVEP tracking device 100 can track the SSVEP signal based on the first fixed window (operation S340).

When it is determined that there is the control intention, the adaptive window-based asynchronous SSVEP tracking device 100 can track the SSVEP signal based on the adaptive window (operation S350).

The adaptive window-based asynchronous SSVEP tracking device 100 can determine whether the user controls the visual stimulation through SSVEP signal tracking (operation S360).

The adaptive window-based asynchronous SSVEP tracking device 100 can determine the user's control state through various types of visual feedback presented in synchronization with the SSVEP signal.

The adaptive window-based asynchronous SSVEP tracking device 100 can decrease the size of the adaptive window when it is determined that the user does not control the visual stimulation (operation S370).

When it is determined that the user controls the visual stimulation, the adaptive window-based asynchronous SSVEP tracking device 100 can increase the size of the adaptive window (operation S380).

When it is determined that the user does not control the visual stimulation and has no control intention at the same time, the adaptive window-based asynchronous SSVEP tracking device 100 can stop the BCI system and the presentation of the visual stimulation (operation S390).

FIG. 4 is a flowchart illustrating a method of identifying a control intention of a user.

In FIG. 4, the adaptive window-based asynchronous SSVEP tracking device 100 can collect an EEG signal of a user in a standby state in which the user is not exposed to visual stimulation (operation S410).

The adaptive window-based asynchronous SSVEP tracking device 100 can use a first EEG signal in the standby state as a base, and determine a second EEG signal in the user's intentional control state for the visual stimulation as an outlier (operation S420).

The adaptive window-based asynchronous SSVEP tracking device 100 can estimate the normal distribution from the features collected for the first EEG signal and estimate the outlier through a mean and standard deviation (operation S430).

When the outlier is detected, the adaptive window-based asynchronous SSVEP tracking device 100 can identify that the user has the control intention for the visual stimulation (operation S440).

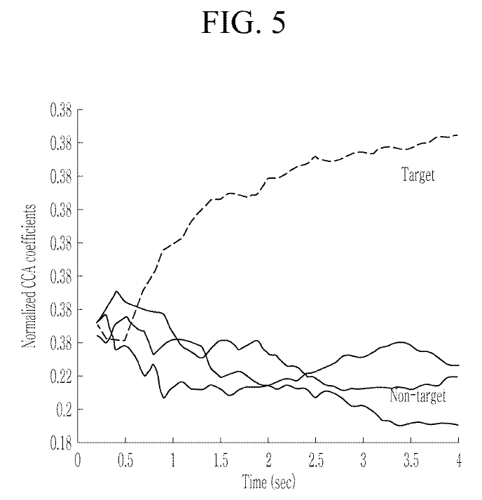

FIG. 5 is a graph illustrating a change in CCA feature characteristics according to a time window size according to an exemplary implementation of the present disclosure.

FIG. 5 illustrates the characteristics that as the time window in which the user controls a specific target with his/her own intention increases, the normalized feature (L1-normal (ρ) value of the target stimulation extracted through CCA increases and the normalized feature value of the non-target decreases.

The adaptive window-based asynchronous SSVEP tracking device 100 can assume an EEG in a non-control state in which the user is not exposed to stimulation as a base signal and EEG feature data for SSVEP stimulation control as an outlier.

The adaptive window-based asynchronous SSVEP tracking device 100 can determine the user's intentional control state through outlier detection that determines the case where the user is looking at one of the four stimuli as an outlier, as illustrated in the graph.

When an outlier appears, the adaptive window-based asynchronous SSVEP tracking device 100 can determine that the user is being observed and start the operation of the SSVEP tracking algorithm.

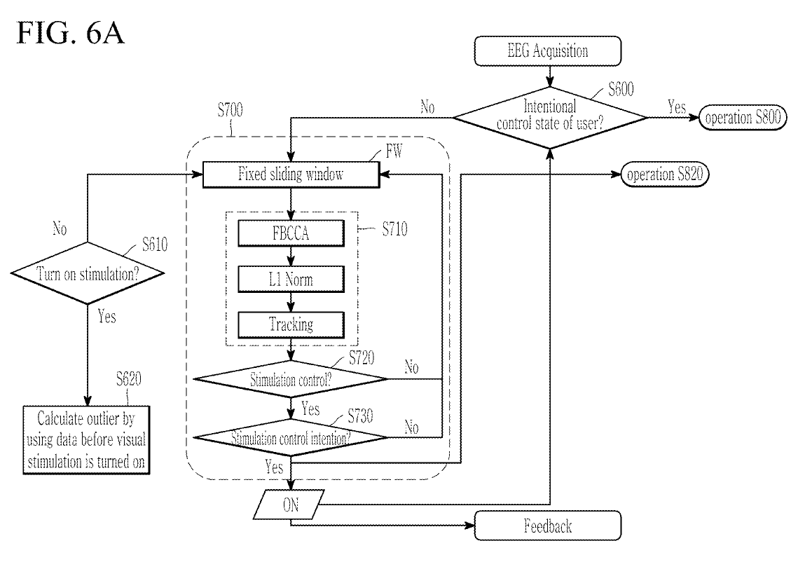

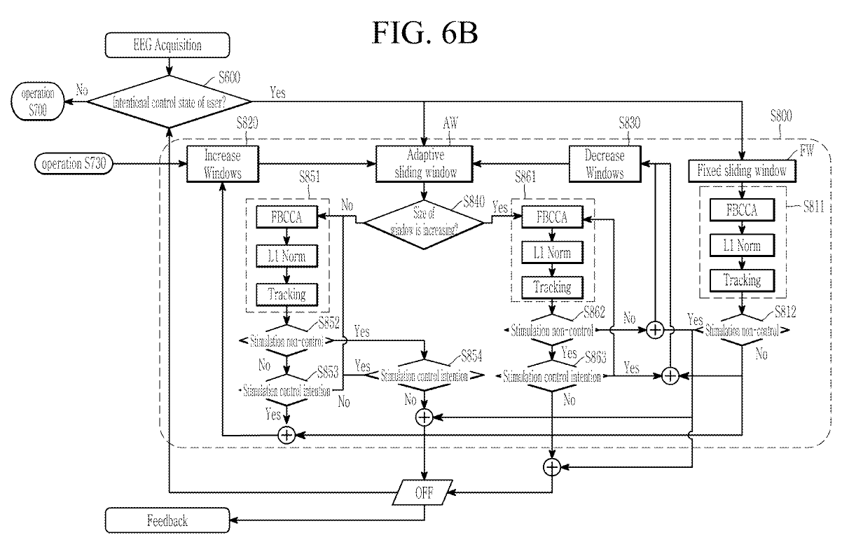

FIGS. 6A and 6B are detailed flowcharts of the adaptive window-based asynchronous SSVEP tracking method according to an exemplary implementation of the present disclosure. The adaptive window-based asynchronous SSVEP tracking method of FIG. 6 can be performed through the adaptive window-based asynchronous SSVEP tracking device 100 (see FIG. 2).

FIG. 6A illustrates an algorithm S700 of the adaptive window-based asynchronous SSVEP tracking method according to an exemplary implementation in a user's non-control state.

In FIG. 6A, the adaptive window-based asynchronous SSVEP tracking device 100 can determine whether the user is in the intentional control state (operation S600), and perform the window-based asynchronous SSVEP tracking method according to operation S700 when it is determined that the user is in a non-control state.

The adaptive window-based asynchronous SSVEP tracking device 100 can track the SSVEP signal using the fixed sliding window FW until the visual stimulation is turned on (operation S610).

When the visual stimulation is turned on, the adaptive window-based asynchronous SSVEP tracking device 100 can calculate an outlier by using data before the visual stimulation is turned on (operation S620). The outlier can indicate the user’s intentional control state.

For example, the adaptive window-based asynchronous SSVEP tracking device 100 can determine the user's intentional control state by calculating an outlier in the user's control state.

The adaptive window-based asynchronous SSVEP tracking device 100 can classify and track a visual stimulation that the user is controlling through the SSVEP signal tracking algorithm using the fixed sliding window (or the fixed moving window) (operation S710).

In operation S710, the adaptive window-based asynchronous SSVEP tracking device 100 can recognize and detect an SSVEP signal through FBCCA or CCA.

Canonical correlation analysis (CCA) can recognize and detect the frequency (Max) with the largest correlation coefficient as the target visual stimulation which the user intentionally controls through analysis between the reference signal for each visual stimulation composed of frequency components used as SSVEP visual stimulation and the EEG signal (EEG signal) measured by the visual stimulation.

Filter bank canonical correlation analysis (FBCCA) can be an extended CCA technique that can perform each CCA analysis after decomposing the signal into multiple frequency bands by using multiple band-pass filters.

The adaptive window-based asynchronous SSVEP tracking device 100 can determine and track the target visual stimulation based on the characteristics that the normalized feature (L1-normal (ρ) value of the target stimulation extracted through CCA increases as the time window in which the user controls the specific target with his or her own intention increases, and the normalized feature value of the non-target decreases as described in FIG. 5.

The adaptive window-based asynchronous SSVEP tracking device 100 can track whether the user is controlling the visual stimulation through tracking of the SSVEP signal (operation S720).

The adaptive window-based asynchronous SSVEP tracking device 100 can determine whether the user controls the visual stimulation based on various types of visual feedback presented together with the visual stimulation and synchronized with the SSVEP signal.

For example, the adaptive window-based asynchronous SSVEP tracking device 100 can determine whether the user controls the visual stimulation through count-based visual feedback that changes in synchronization with the SSVEP signal, and sets to have a minimum value in the control state and a maximum value in the non-control state for the visual stimulation.

In this case, the adaptive window-based asynchronous SSVEP tracking device 100 can determine that the user is in the control state when the count value presented as the visual feedback is minimum, and determine that the user is in the non-control state when the count value presented as the visual feedback is maximum.

The adaptive window-based asynchronous SSVEP tracking device 100 can perform operation S710 again when the user is not controlling the visual stimulation.

The adaptive window-based asynchronous SSVEP tracking device 100 can determine whether it is an outlier section when the user controls the visual stimulation (operation S730).

For example, the adaptive window-based asynchronous SSVEP tracking device 100 collects EEG data (base state) when the user is not looking at anything (standby state), and based on this, when the normalized feature value of the normal distribution-based target visual stimulation exceeds 3 ρ, it can be determined as an outlier.

The adaptive window-based asynchronous SSVEP tracking device 100 can perform operation S710 again as long as it is not the outlier section.

For example, when it is determined that the user is continuously intentionally controlling the visual stimulation, the adaptive window-based asynchronous SSVEP tracking device 100 can determine that the user is in the intentional control state and operate the algorithm of operation S800.

The adaptive window-based asynchronous SSVEP tracking device 100 can increase the size of the adaptive window when it is determined that the user is in the intentional control state for the target visual stimulation (operation S820).

FIG. 6B illustrates an algorithm (operation S800) of the adaptive window-based asynchronous SSVEP tracking method according to an exemplary implementation in an intentional control state of a user.

In FIG. 6B, when it is identified that the user has the control intention (operation S600), the adaptive window-based asynchronous SSVEP tracking device 100 can track the adaptive window-based SSVEP signal (operation S800).

The adaptive window-based asynchronous SSVEP tracking device 100 can multi-track the SSVEP signal by using the fixed sliding window FW together with the adaptive sliding window AW.

The adaptive window-based asynchronous SSVEP tracking device 100 can preemptively track the non-control state by using the fixed sliding window FW for tracking together with the adaptive sliding window AW because the detection response speed to the non-control state of the stimulation is decreased when the size of the adaptive sliding window AW increases.

The adaptive window-based asynchronous SSVEP tracking device 100 can preferentially track the user's control state or non-control state for the visual stimulation by using the fixed sliding window FW (operation S811).

The adaptive window-based asynchronous SSVEP tracking device 100 can track the control state using a fixed sliding window FW-based SSVEP signal classification and tracking algorithm (hereinafter, SSVEP signal tracking algorithm) in operation S710.

The adaptive window-based asynchronous SSVEP tracking device 100 can determine whether the user does not control the visual stimulation according to the SSVEP signal tracking (operation S812).

For example, the adaptive window-based asynchronous SSVEP tracking device 100 can determine that the user is in the non-control state when the count value of the visual feedback synchronized with the SSVEP signal described above has a maximum value.

The adaptive window-based asynchronous SSVEP tracking device 100 can increase the size of the adaptive window when it is determined that the user is controlling the visual stimulation and has the control intention (operation S820).

The adaptive window-based asynchronous SSVEP tracking device 100 can continuously increase the size of the adaptive sliding window AW to a preset maximum size in response to the detected control state when the control state is continuously detected based on the SSVEP signal tracked through the adaptive sliding window AW or the fixed sliding window FW.

In other words, the adaptive window-based asynchronous SSVEP tracking device 100 can increase the size of the adaptive sliding window AW by the signal input in real time and limits the size of the adaptive sliding window AW to the initially set maximum size in order to secure signal stability in the control state.

The adaptive window-based asynchronous SSVEP tracking device 100 can maintain the maximum size when the size of the window reaches the maximum state, perform windowing, and continuously track the SSVEP signal in the AO state.

The adaptive window-based asynchronous SSVEP tracking device 100 can decrease the size of the adaptive window when it is determined that the user does not control the visual stimulation based on the tracked SSVEP signal (operation S830).

When it is detected that the user is in the non-control state for the visual stimulation based on the SSVEP signal tracked through the fixed sliding window FW (S812), the adaptive window-based asynchronous SSVEP tracking device 100 can decrease the size of the adaptive sliding window AW (operation S830).

The adaptive window-based asynchronous SSVEP tracking device 100 can continuously determine whether the user is controlling the visual stimulation based on the SSVEP signal tracked through the adaptive sliding window AW.

The adaptive window-based asynchronous SSVEP tracking device 100 can determine whether the size of the adaptive sliding window AW is increasing (operation S840).

When it is determined that the window size is increasing, the adaptive window-based asynchronous SSVEP tracking device 100 can perform the SSVEP signal tracking algorithm (operation S861) to determine whether the user does not control the visual stimulation (operation S862).

When it is determined that the user does not control the visual stimulation and has no control intention (not outlier) at the same time (operation S863), the adaptive window-based asynchronous SSVEP tracking device 100 can stop presenting the visual stimulation.

The adaptive window-based asynchronous SSVEP tracking device 100 can stop presenting the visual stimulation when it is detected that the user is in the non-control state according to both a result of the tracking of the SSVEP signal through the adaptive sliding window AW and a result of the tracking of the SSVEP signal through the second fixed window.

When it is determined that the window size is decreasing, the adaptive window-based asynchronous SSVEP tracking device 100 can perform the SSVEP signal tracking algorithm (operation S851) to determine whether the user does not control the visual stimulation (operation S852).

When it is detected that the user is in the control state according to both a result of the tracking of the SSVEP signal through the fixed sliding window FW and a result of the tracking of the SSVEP signal through the adaptive sliding window AW while the window size is decreasing (operations S812 and S852), the adaptive window-based asynchronous SSVEP tracking device 100 can increase the size of the adaptive sliding window AW again.

In this case, the adaptive window-based asynchronous SSVEP tracking device 100 can determine outlier through the adaptive sliding window AW (operations S853 and S854).

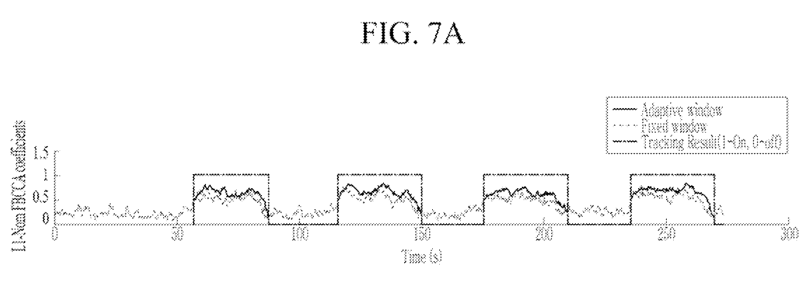

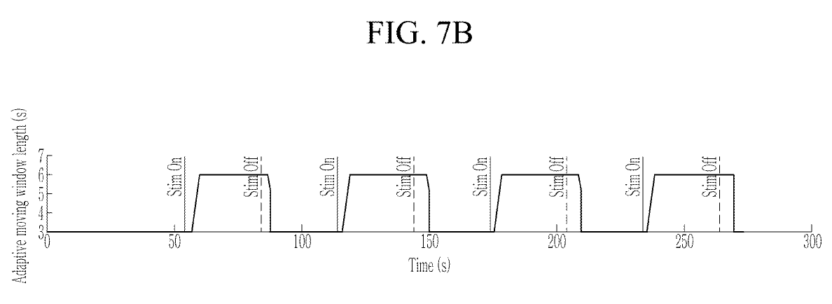

FIGS. 7A and 7B are graphs illustrating effects according to the exemplary implementation of the present disclosure.

In FIGS. 7A and 7B, the performance of SSVEP tracking was compared between the case where SSVEP signal tracking was performed only with a fixed window and the case where SSVEP signal tracking was performed using an adaptive window while repeatedly presenting or not presenting visual stimulation over time.

FIG. 7A is a graph illustrating the comparison between the case in which SSVEP signal tracking is performed only with a fixed window and the case in which SSVEP signal tracking is performed using an adaptive window.

FIG. 7B is a graph illustrating a size change over time of an adaptive window.

In FIG. 7B, the adaptive window starts to increase as soon as the stimulation is turned on, maintains a maximum value (6 seconds) until the stimulation is turned off, and returns to a minimum value (3 seconds) when the stimulation is turned off.

Here, the moment when the stimulation is turned on can correspond to the control state in which the user controls the visual stimulation, and the moment when the stimulation is turned off can correspond to the non-control state in which the user does not control the visual stimulation.

In FIGS. 7A and 7B, it can be seen that the SSVEP signal tracking performance is further improved in the case of using the adaptive window than in the case of using only the fixed window.

FIG. 8 is a diagram illustrating a computing device according to an exemplary implementation of the present disclosure.

Referring to FIG. 8, the adaptive window-based asynchronous SSVEP tracking device and method according to the exemplary implementations can be implemented by using a computing device 900.

The computing device 900 can include at least one of a processor 910, a memory 930, a user interface input device 940, a user interface output device 950, and a storage device 560 communicating via a bus 920. The computing device 900 can also include a network interface 970 that is electrically connected to a network 90. The network interface 970 can transmit or receive a signal with another entity through the network 40.

The processor 910 can be implemented in various types, such as a Micro Controller Unit (MCU), an Application Processor (AP), a Central Processing Unit (CPU), a Graphic Processing Unit (GPU), a Neural Processing Unit (MPU), and the like, and can be a predetermined semiconductor device executing commands stored in the memory 930 or the storage device 960. The processor 910 can be configured to implement the functions and the methods described above with reference to FIGS. 1 to 7.

The memory 930 and the storage device 960 can include various forms of volatile or non-volatile storage media. For example, the memory can include a Read Only Memory (ROM) 931 and a Random Access Memory (RAM) 932. In the exemplary implementation, the memory 930 can be located inside or outside the processor 910, and the memory 930 can be connected with the processor 910 through already known various means.

In some exemplary implementations, at least some configurations or functions of the adaptive window-based asynchronous SSVEP tracking device and method according to the exemplary implementations can be implemented as programs or software executed on the computing device 900, and the programs or software can be stored on a computer-readable medium.

In some exemplary implementations, at least some configurations or features of the adaptive window-based asynchronous SSVEP tracking device and method according to the exemplary implementations can be implemented using hardware or circuit of the computing device 900, or can be implemented as separate hardware or circuit that can be electrically connected to computing device 900.

In some implementations, all of the functions of the system/device/module/unit described herein may be performed by a single processor. In other implementations, the functions of the system/device/module/unit described herein may be distributed among multiple processors (e.g., one processor performs a subset of the functions while one or more other processors perform the remaining functions).

Although the above exemplary implementations of the present disclosure have been described in detail, the scope of the present disclosure is not limited thereto, but also includes various modifications and improvements by one of ordinary skill in the art utilizing the basic concepts of the present disclosure as defined in the following claims.

What is claimed is:

1. An adaptive window-based asynchronous steady state visually evoked potential (SSVEP) tracking device comprising:
one or more processors; and
memory storing instructions that, when executed by the one or more processors, cause the adaptive window-based asynchronous SSVEP tracking device to:
receive an electroencephalogram (EEG) signal of a user,
based on starting a presentation of a visual stimulation, determine a control intention of the user for the visual stimulation based on the EEG signal,
based on determining that there is no control intention, track an SSVEP signal based on a first fixed window,
based on determining that there is the control intention, track the SSVEP signal based on an adaptive window,
based on determining that the user controls the visual stimulation and has the control intention based on the tracked SSVEP signal, increase a size of the adaptive window,
based on determining that the user does not control the visual stimulation based on the tracked SSVEP signal, decrease the size of the adaptive window, and
based on determining that the user does not control the visual stimulation and has no control intention, stop the presentation of the visual stimulation.

2. The adaptive window-based asynchronous SSVEP tracking device of claim 1, wherein the instructions, when executed by the one or more processors, cause the adaptive window-based asynchronous SSVEP tracking device to determine the control intention of the user for the visual stimulation based on the EEG signal based on starting the presentation of the visual stimulation by:
determining a first EEG signal in a standby state before the presentation of the visual stimulation as a base signal, and determining a second EEG signal in an intentional control state for the visual stimulation as an outlier;
detecting the outlier based on a normalized feature of the first EEG signal; and
determining that there is the control intention for the visual stimulation based on detecting the outlier.

3. The adaptive window-based asynchronous SSVEP tracking device of claim 2, wherein the instructions, when executed by the one or more processors, cause the adaptive window-based asynchronous SSVEP tracking device to detect the outlier based on the normalized feature of the first EEG signal by estimating a normal distribution from features collected in the standby state, and estimating the outlier through a mean and standard deviation.

4. The adaptive window-based asynchronous SSVEP tracking device of claim 1, wherein the instructions, when executed by the one or more processors, cause the adaptive window-based asynchronous SSVEP tracking device to track the SSVEP signal based on the adaptive window based on determining that there is the control intention by multi-tracking the SSVEP signal by using a second fixed window together with the adaptive window.

5. The adaptive window-based asynchronous SSVEP tracking device of claim 4, wherein the instructions, when executed by the one or more processors, cause the adaptive window-based asynchronous SSVEP tracking device to multi-track the SSVEP signal by using the second fixed window together with the adaptive window by preferentially tracking a control state or a non-control state of the user for the visual stimulation by using the second fixed window.

6. The adaptive window-based asynchronous SSVEP tracking device of claim 5, wherein the instructions, when executed by the one or more processors, cause the adaptive window-based asynchronous SSVEP tracking device to increase the size of the adaptive window based on determining that the user controls the visual stimulation and has the control intention based on the tracked SSVEP signal by, based on detecting the control state based on the SSVEP signal tracked through the adaptive window or the second fixed window, increasing the size of the adaptive window to a preset maximum size based on the detected control state.

7. The adaptive window-based asynchronous SSVEP tracking device of claim 6, wherein the instructions, when executed by the one or more processors, cause the adaptive window-based asynchronous SSVEP tracking device to increase the size of the adaptive window based on determining that the user controls the visual stimulation and has the control intention based on the tracked SSVEP signal further by, based on the size of the adaptive window reaching the preset maximum size, maintaining the preset maximum size and tracking the SSVEP signal.

8. The adaptive window-based asynchronous SSVEP tracking device of claim 5, wherein the instructions, when executed by the one or more processors, cause the adaptive window-based asynchronous SSVEP tracking device to decrease the size of the adaptive window based on determining that the user does not control the visual stimulation based on the tracked SSVEP signal by:
based on detecting the non-control state of the user for the visual stimulation based on the SSVEP signal tracked through the second fixed window, decreasing the size of the adaptive window; and
determining whether the user controls the visual stimulation based on the SSVEP signal tracked through the adaptive window.

9. The adaptive window-based asynchronous SSVEP tracking device of claim 5, wherein the instructions, when executed by the one or more processors, cause the adaptive window-based asynchronous SSVEP tracking device to stop the presentation of the visual stimulation based on determining that the user does not control the visual stimulation and has no control intention by stopping the presentation of the visual stimulation based on detecting the non-control state according to both a result of the tracking of the SSVEP signal through the adaptive window and a result of the tracking of the SSVEP signal through the second fixed window.

10. The adaptive window-based asynchronous SSVEP tracking device of claim 5, wherein the instructions, when executed by the one or more processors, cause the adaptive window-based asynchronous SSVEP tracking device to, based on detecting the control state according to both a result of the tracking of the SSVEP signal through the second fixed window and a result of the tracking of the SSVEP signal through the adaptive window during a decrease in the size of the adaptive window, increase the size of the adaptive window that has been decreasing.

11. An adaptive window-based asynchronous steady state visually evoked potential (SSVEP) tracking method performed by a computing device including one or more processors and a memory, the adaptive window-based asynchronous SSVEP tracking method comprising:
receiving, by the one or more processors, an electroencephalogram (EEG) signal of a user;
based on starting a presentation of a visual stimulation, determining, by the one or more processors, a control intention of the user for the visual stimulation based on the EEG signal;
based on determining that there is no control intention, tracking, by the one or more processors, an SSVEP signal based on a first fixed window;
based on determining that there is the control intention, tracking, by the one or more processors, the SSVEP signal based on an adaptive window;
based on determining that the user controls the visual stimulation and has the control intention based on the tracked SSVEP signal, increasing, by the one or more processors, a size of the adaptive window;
based on determining that the user does not control the visual stimulation based on the tracked SSVEP signal, decreasing, by the one or more processors, the size of the adaptive window; and
based on determining that the user does not control the visual stimulation and has no control intention, stopping, by the one or more processors, the presentation of the visual stimulation.

12. The adaptive window-based asynchronous SSVEP tracking method of claim 11, wherein:
the determining of the control intention of the user for the visual stimulation based on the EEG signal based on starting the presentation of the visual stimulation begins comprises:
determining, by the one or more processors, a first EEG signal in a standby state before the presentation of the visual stimulation as a base signal, and determining a second EEG signal in an intentional control state for the visual stimulation as an outlier;
detecting the outlier based on a normalized feature of the first EEG signal; and
determining that there is the control intention for the visual stimulation based on detecting the outlier.

13. The adaptive window-based asynchronous SSVEP tracking method of claim 12, wherein the detecting of the outlier based on the normalized feature of the first EEG signal comprises estimating a normal distribution from features collected in the standby state, and estimating the outlier through a mean and standard deviation.

14. The adaptive window-based asynchronous SSVEP tracking method of claim 11, wherein the tracking of the SSVEP signal based on the adaptive window based on determining that there is the control intention comprises multi-tracking the SSVEP signal by using a second fixed window together with the adaptive window.

15. The adaptive window-based asynchronous SSVEP tracking method of claim 14, wherein the multi-tracking of the SSVEP signal by using the second fixed window together with the adaptive window comprises preferentially tracking a control state or a non-control state of the user for the visual stimulation by using the second fixed window.

16. The adaptive window-based asynchronous SSVEP tracking method of claim 15, wherein the increasing of the size of the adaptive window based on determining that the user controls the visual stimulation and has the control intention based on the tracked SSVEP signal comprises, based on detecting the control state based on the SSVEP signal tracked through the adaptive window or the second fixed window, increasing the size of the adaptive window to a preset maximum size based on the detected control state.

17. The adaptive window-based asynchronous SSVEP tracking method of claim 16, wherein:
the increasing of the size of the adaptive window based on determining that the user controls the visual stimulation and has the control intention based on the tracked SSVEP signal further comprises,
based on the size of the adaptive window reaching the preset maximum size, maintaining the preset maximum size and tracking the SSVEP signal.

18. The adaptive window-based asynchronous SSVEP tracking method of claim 15, wherein the decreasing of the size of the adaptive window based on determining that the user does not control the visual stimulation based on the tracked SSVEP signal comprises:
based on detecting the non-control state of the user for the visual stimulation based on the SSVEP signal tracked through the second fixed window, decreasing the size of the adaptive window; and
determining whether the user controls the visual stimulation based on the SSVEP signal tracked through the adaptive window.

19. The adaptive window-based asynchronous SSVEP tracking method of claim 15, wherein the stopping of the presentation of the visual stimulation based on determining that the user does not control the visual stimulation and has no control intention comprises stopping the presentation of the visual stimulation based on detecting the non-control state according to both a result of the tracking of the SSVEP signal through the adaptive window and a result of the tracking of the SSVEP signal through the second fixed window.

20. The adaptive window-based asynchronous SSVEP tracking method of claim 15, comprising:
based on detecting the control state according to both a result of the tracking of the SSVEP signal through the second fixed window and a result of the tracking of the SSVEP signal through the adaptive window during a decrease in the size of the adaptive window, increasing the size of the adaptive window that has been decreasing.
